(19) United States
(12) Patent Application Publication
(10) Pub. No.: US 2013/0146200 A1
(43) Pub. Date: Jun. 13, 2013

(54) OVERLAY PLY FOR A PNEUMATIC TIRE

(71) Applicants: Walter Kevin Westgate, Uniontown, OH (US); Florencio Lim Gopez, Chesterfield, VA (US); Nathan Whitney Love, Richmond, VA (US)

(72) Inventors: Walter Kevin Westgate, Uniontown, OH (US); Florencio Lim Gopez, Chesterfield, VA (US); Nathan Whitney Love, Richmond, VA (US)

(21) Appl. No.: 13/324,204

(22) Filed: Dec. 13, 2011

(51) Int. Cl. B60C 9/02; B60C 9/18

(52) U.S. Cl. 152/527

(57) ABSTRACT

A pneumatic tire includes a carcass ply and a belt structure having an overlay ply disposed radially outward of the carcass ply in a crown portion of the tire. The overlay ply comprises at least one composite cord. The cord comprises one aramid first yarn twisted helically about one nylon second yarn. The first yarn has a first modulus of elasticity and the second yarn has a second modulus of elasticity.

### FIELD OF THE INVENTION

The present invention is directed towards a pneumatic tire. More specifically, the present invention is directed towards a pneumatic tire wherein an overlay reinforcement layer reduces belt package stiffness of the pneumatic tire.

### BACKGROUND OF THE INVENTION

One conventional overlay for a pneumatic tire utilizes a hybrid cord. The hybrid cord is formed of two different materials: a low initial modulus core yarn and high modulus wrap yarns. The selection of the yarns is such that the “break point” of the cord, i.e. when the slope of the force versus elongation curve changes from a relatively low slope to a relatively high slope, occurs at between 2% and 3% elongation, with an ultimate cord break at just over 5% elongation.

Another conventional overlay utilizes a hybrid cord of aramid and nylon twisted together, wherein the break point of the cord is between 4% and 6% elongation, with an ultimate cord break at over 10% elongation. In an overlay, the hoop reinforcing effects of a strong cord are desired. However, the cord must have elongation properties to a degree to permit the tire to expand into a toroidal shape during tire molding and bending stiffness properties to a degree to permit some ride comfort characteristics.

A conventional runflat tire may exhibit bending behavior of tire components to achieve improved comfort and handling performance, and also improved run-flat performance. This runflat pneumatic tire may have a single carcass ply, at least one belt ply disposed radially outward of the carcass ply in a crown portion of the tire, and at least one insert located adjacent the carcass ply in a sidewall portion. The insert may provide support for the pneumatic tire load to enable the tire to operate in underinflated conditions. The carcass ply comprises at least one composite cord formed of at least two first yarns twisted helically about at least one second yarn. The first yarns and the second yarn having different modulus of elasticity, the first yarns having a modulus greater than the modulus of the second yarn. The first and second yarns may be selected from the group of materials of aramid, PK, PBO, rayon, nylon, polyester, PET, and PEN. The first yarns may have a linear density value in the range of 550 to 3300 dtex, while the second yarns may have a linear density value in the range of 940 dtex to 3680 dtex.

### DEFINITIONS

“Apex” means an elastomeric filler located radially above the bead core and between the plies and the turnup ply.

“Annular” means formed like a ring.

“Aspect ratio” means the ratio of its section height to its section width.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). Dtex means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Gauge” refers generally to a measurement, and specifically to a thickness measurement.

“High Tensile Steel (HT)” means a carbon steel with a tensile strength of at least 3400 MPa @ 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“LASE” is load at specified elongation.

“Lateral” means an axial direction.

“Lay length” means the distance at which a twisted filament or strand travels to make a 360 degree rotation about another filament or strand.

“Load Range” means load and inflation limits for a given tire used in a specific type of service as defined by tables in The Tire and Rim Association, Inc.

“Mega Tensile Steel (MT)” means a carbon steel with a tensile strength of at least 4500 MPa @ 0.20 mm filament diameter.

“Normal Load” means the specific design inflation pressure and load assigned by the appropriate standards organization for the service condition for the tire.

“Normal Tensile Steel (NT)” means a carbon steel with a tensile strength of at least 2800 MPa @ 0.20 mm filament diameter.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Rivet” means an open space between cords in a layer.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Sidewall” means that portion of a tire between the tread and the bead.

“Stiffness ratio” means the value of a control belt structure stiffness divided by the value of another belt structure stiffness when the values are determined by a fixed three point bending test having both ends of the cord supported and flexed by a load centered between the fixed ends.

“Super Tensile Steel (ST)” means a carbon steel with a tensile strength of at least 3650 MPa @ 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra Tensile Steel (UT)” means a carbon steel with a tensile strength of at least 4000 MPa @ 0.20 mm filament diameter.

“Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

### SUMMARY OF THE INVENTION

A first pneumatic tire in accordance with the present invention comprises a carcass ply and a belt structure having an overlay ply disposed radially outward of the carcass ply in a crown portion of the tire. The overlay ply comprises at least one composite cord. The cord comprises one aramid first yarn twisted helically about one nylon second yarn. The first yarn has a first modulus of elasticity and the second yarn has a second modulus of elasticity.

In accordance with another aspect of the first tire, the first yarn has a linear density value in the range of 500 dtex to 800 dtex.

In accordance with still another aspect of the first tire, the second yarn has a linear density value in the range of 200 dtex to 800 dtex.

In accordance with yet another aspect of the first tire, the composite cords have an end count per inch in the overlay ply in the range of 10-25 (3.9-9.8 ends per cm).

A second pneumatic tire in accordance with the present invention comprises a carcass ply and a belt structure having an overlay ply disposed radially outward of the carcass ply in a crown portion of the tire. The overlay ply comprises at least one composite cord. The cord comprises one aramid first yarn twisted helically about one aramid second yarn. The first yarn has a first modulus of elasticity and the second yarn has a second modulus of elasticity.

In accordance with another aspect of the second tire, the first yarn has a linear density value in the range of 500 dtex to 800 dtex.

In accordance with still another aspect of the second tire, the second yarn has a linear density value in the range of 500 dtex to 800 dtex.

In accordance with still another aspect of the second tire, the composite cords have an end count per inch in the overlay ply in the range of 10-25 (3.9-9.8 ends per cm).

### BRIEF DESCRIPTION OF THE DRAWINGS

The invention will be described by way of example and with reference to the accompanying drawings in which:

FIG. 1 is a cross sectional view of an example tire for use with the present invention; and

FIG. 2 is an example cord construction in accordance with the present invention.

### DETAILED DESCRIPTION OF EXAMPLES OF THE PRESENT INVENTION

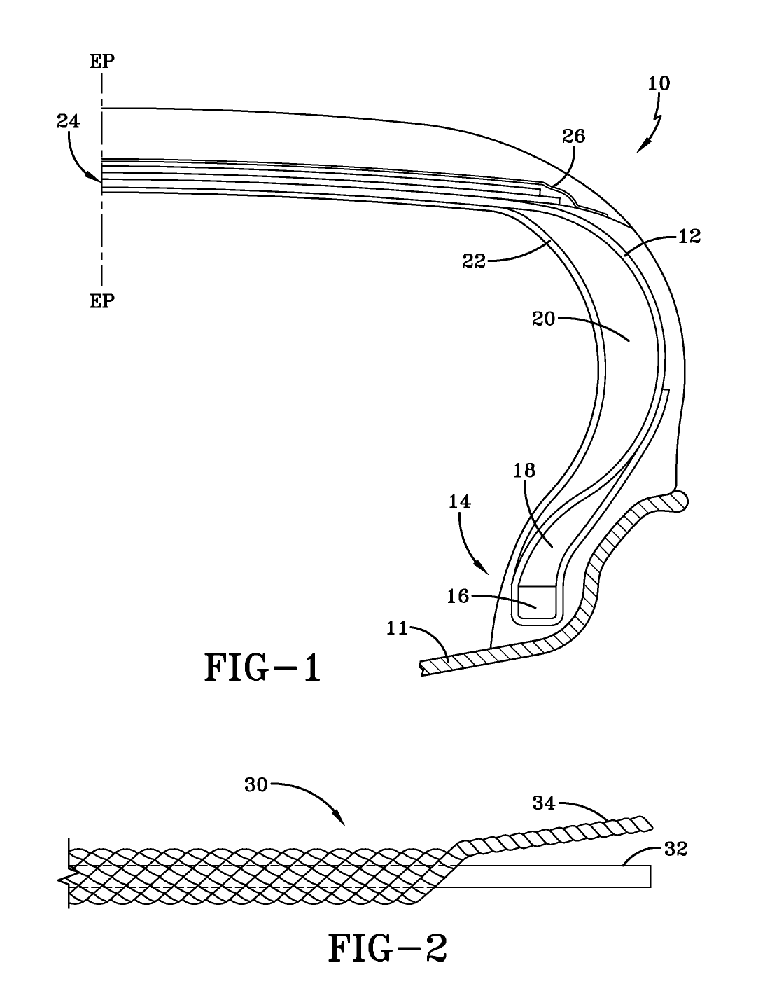

FIG. 1 is a cross-sectional view of an example pneumatic runflat tire 10, mounted on a tire rim 11, designed to be capable of continued operation during under-inflated or deflated conditions. Only one half of the tire 10 is shown, it being understood that, conventionally, the other half is a mirror image of that which is illustrated. The example tire 10 has at least one reinforcing ply 12 extending from one bead area 14 of the tire to an opposing bead area. The ends of the reinforcing ply 12 are turned axially inward to axially outward about bead cores 16 and bead apexes 18. The terminal ends of the reinforcing ply 12 extend past the radially outer ends of the bead apexes 18 enveloping the bead apexes 18.

Located in each sidewall region of the example tire 10 may be a sidewall insert 20. The insert 20 may be located adjacent to the tire innerliner 22 or axially outward of the reinforcing ply 12. The insert 20 may be formed of elastomeric material and may extend from the crown area, preferably from radially inward of the belt structure 24, to radially inward of the outermost terminal end of the bead apexes 18, overlapping the bead apexes 18. The elastomeric material of the insert 20 may be selected to provide the tire with support during underinflated operation of the tire 10.

In the crown area of the example tire 10, a belt structure 24 may be located radially outward of the carcass ply 12. The belt structure 24 may have at least two inclined, crossed cord belt plies and an overlay ply 26. The cords in the belt plies may be inclined with respect to the circumferential direction and the cords in directly adjacent plies may be inclined at similar, but opposing, angles to each other. Outward of the cross cord plies may be the overlay ply 26. The overlay ply 26 may have a width equal or greater than the maximum width of the crossed cord plies, encapsulating the crossed cord plies of the belt structure 24 between the overlay ply 26 and the carcass reinforcing ply 12. The overlay ply 26 may be reinforced with cords inclined at angles of 15° or less relative to the equatorial plane (EP) of the example tire 10.

In accordance with the present invention, the overlay ply 26 may be formed from a cord 30, as seen in FIG. 2. To reduce stiffness of the overall belt structure 24, the bending stiffness of the belt structure may be lowered by reducing the gauge, or thickness, of the overlay ply 26. Thus, ride comfort (e.g. during an impact) may be enhanced, in addition to maintaining acoustical performance through the use of merged cord technology. Through the use of an overlay ply 26 in accordance with the present invention, the gauge of the cords 30 may be reduced (e.g., 35% reduction), thereby reducing bending stiffness of the belt structure 24 and enhancing ride comfort without sacrificing other key tire performance parameters (e.g., handling, wear, etc.).

The cord 30 may be a composite cord made of filament yarns of appropriate gauge and stress-strain characteristics to provide the example tire 10. As an example, the cord 30 may be formed of a single first yarn 32 about which is twisted a single second yarn 34. This construction allows the overlay ply 26 and belt structure 24 to have relatively low bending stiffness strain (e.g., enhancing comfort) while not having a negative impact on other performance characteristics of the example tire 10.

Possible reinforcing materials for either the first or second yarns 32, 34 may include, but are not limited to, aramid, polyethylene ketone (PK), polyphenylene-2,6-benzobisoxazole (PBO), rayon, nylon, polyester, polyamide, polyethylene terephthalate (PET), polyethylene napthalate (PEN), and polyvinyl alcohol (PVA). Particularly, a unique construction of a nylon core yarn 32 with an aramid yarn 34 twisted about the core yarn for the cords 30 of the overlay ply 26 may produce such characteristics (e.g., (500-800 dtex/1+350−600 dtex/1)/(400−800)Z+(400−800)Z/(200−800)S. One example construction may be (670 dtex/1 aramid+470 dtex/1 nylon)/(591Z/394Z/591S) with an end count per inch in the overlay ply 26 in the range of 10-20 (3.9-7.9 ends per cm). Another example construction may be (670 dtex/½ aramid)/(748Z/748Z/591S) with an end count per inch in the overlay ply 26 in the range of 10-20 (3.9-7.9 ends per cm). Another example construction may be (670 dtex/½ aramid)/(748Z/748Z/591S) with an end count per inch in the overlay ply 26 in the range of 15-25 (5.9-9.8 ends per cm). Another example construction may be (670 dtex/1 aramid+470 dtex/1 nylon)/(591Z/59S/591S) with an end count per inch in the overlay ply 26 in the range of 15-25 (5.9-9.8 ends per cm).

Other example materials may be aramid, PK, PVA, PBO, rayon, nylon, polyester, PET, or PEN. The final material selection may be based on the specific desired stress/strain characteristics vs. gauge of the cord 30. In the example cord 30, each of the yarns 32, 34 has its component filaments twisted together a given number of turns per unit of length of the yarn 32, 34 (usually expressed in turns per inch (TPI)) and additionally the yarns 32, 34 are twisted together a given number of turns per unit of length of the cord 30. The direction of twist refers to the direction of slope of the spirals of a yarn or cord when it is held vertically. If the slope of the spirals conform in direction to the slope of the letter “S”, then the twist is called “S”, or “left hand”. If the slope of the spirals conform in direction to the slope of the letter “Z”, then the twist is called “Z”, or “right hand”. An “S” or “left hand” twist direction is understood to be an opposite direction from a “Z” or “right hand” twist. “Yarn twist” is understood to mean the twist imparted to a yarn before the yarn is incorporated into a cord, and “cord twist” is understood to mean the twist imparted to two or more yarns when they are twisted together with one another to form a cord. “dtex” is understood to mean the weight in grams of 10,000 meters of a yarn before the yarn has a twist imparted thereto.

As stated above, an overlay ply 26 of hybrid cords 30 in accordance with the present invention produces excellent comfort performance in a tire 10 as well as allowing a reduction in ply gauge without sacrificing performance. This overlay ply 26 thus enhances the performance of the tire 10, even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry. Mayni.

A pneumatic tire has certain essential structural elements. United States Department of Transportation, Mechanics of Pneumatic Tires, pages 207-208 (1981). An important structural element is the carcass ply, typically made up of many flexible, high modulus cords of natural textile, synthetic polymer, glass fiber, or fine hard drawn steel embedded in, and bonded to, a matrix of low modulus polymeric material, usually natural or synthetic rubber. Id. at 207 through 208.

The flexible, high modulus cords are usually disposed as a single layer. Id. at 208. Tire manufacturers throughout the industry cannot agree or predict the effect of different twists of carcass ply cords on noise characteristics, handling, durability, comfort, etc. in pneumatic tires, Mechanics of Pneumatic Tires, pages 80 through 85.

These complexities are demonstrated by the below table of the interrelationships between tire performance and tire components.

| | LINER | CARCASS PLY | APEX | BELT | OV'LY | TREAD | MOLD |
|---|---|---|---|---|---|---|---|
| TREADWEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE COMFORT | X | X | X | | | X | |
| HIGH SPEED | | X | X | X | X | X | X |
| AIR RETENTION | X | | | | | | |
| MASS | X | X | X | X | X | X | X |

As seen in the table, overlay ply cord characteristics affect the other components of a pneumatic tire 10 (i.e., overlay ply affects carcass, apex, belt, etc.), leading to a number of components interrelating and interacting in such a way as to affect a group of functional properties (noise, handling, durability, comfort, high speed, and mass), resulting in a completely unpredictable and complex composite. Thus, changing even one component can lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the experimentation and testing conducted by the inventors.

Thus, for example, when the structure (i.e., twist, cord construction, etc.) of the overlay ply cords 30 of a pneumatic tire 10 is modified with the intent to improve one functional property of the pneumatic tire, any number of other functional properties may be unacceptably degraded. Furthermore, the interaction between the carcass ply cords and the apex, belt, carcass, and tread may also unacceptably affect the functional properties of the pneumatic tire. A modification of the carcass ply cords may not even improve that one functional property because of these complex interrelationships.

Thus, as stated above, the complexity of the interrelationships of the multiple components makes the actual result of modification of a carcass ply, in accordance with the present invention, impossible to predict or foresee from the infinite possible results. Only through extensive experimentation have the overlay ply 26 and cords 30 of the present invention been revealed as an excellent, unexpected, and unpredictable option for a tire overlay/belt structure.

The previous descriptive language is of the best presently contemplated mode or modes of carrying out the present invention. This description is made for the purpose of illustrating an example of general principles of the present invention and should not be interpreted as limiting the present invention. The scope of the invention is best determined by reference to the appended claims. The reference numerals as depicted in the schematic drawings are the same as those referred to in the specification. For purposes of this application, the various examples illustrated in the figures each use a same reference numeral for similar components. The examples structures may employ similar components with variations in location or quantity thereby giving rise to alternative constructions in accordance with the present invention.

1. A pneumatic tire comprising:
a carcass ply; and
a belt structure having an overlay ply disposed radially outward of the carcass ply in a crown portion of the tire,
the overlay ply comprising at least one composite cord, the cord comprising one aramid first yarn twisted helically about one nylon second yarn, the first yarn having a first modulus of elasticity and the second yarn having a second modulus of elasticity,
the first yarn having a linear density value in the range of 500 dtex to 800 dtex, the second yarn having a linear density value in the range of 200 dtex to 800 dtex, the composite cords having an end count per inch in the overlay ply in the range of 15-25 (5.9-11.9 ends per cm).

2. (canceled)

3. (canceled)

4. (canceled)

5. A pneumatic tire comprising:
a carcass ply; and
a belt structure having an overlay ply disposed radially outward of the carcass ply in a crown portion of the tire,
the overlay ply comprising at least one composite cord, the cord comprising one aramid first yarn twisted helically about one aramid second yarn, the first yarn having a first modulus of elasticity and the second yarn having a second modulus of elasticity.

6. The tire as set forth in claim 5 wherein the first yarn has a linear density value in the range of 500 dtex to 800 dtex.

7. The tire as set forth in claim 6 wherein the second yarn has a linear density value in the range of 500 dtex to 800 dtex.

8. The tire as set forth in claim 7 wherein the composite cords have an end count per inch in the overlay ply in the range of 15-25 (5.9-9.8 ends per cm).
